(19) United States
(12) Patent Application Publication
(10) Pub. No.: US 2004/0035781 A1
(43) Pub. Date: Feb. 26, 2004

(54) Sludge bag

(76) Inventor: Matthew William Egan, Johannesburg (ZA)

Correspondence Address: Eileen E. Hadley, 11380 Cove Lake Rd, Lusby, MD, 20657, US

(21) Appl. No.: 10/372,254

(22) Filed: Feb. 25, 2003

(30) Foreign Application Priority Data
Mar. 21, 2002 (ZA) 87373

(51) Int. Cl. B01D 29/00

(52) U.S. Cl. 210/489

(57) ABSTRACT

There are Two Basic Components

1. An outer bag providing a strong and stable container plus the final screen for any escaped sludge particles.

2. Two inner bags which have the ability to expand and contract, thus retaining and separating solids while permitting liquids, free of solid, to easily pass through to the other bags without restrictions. None of the bags are capable of entrapping free liquid. After a while the entrapped solids presents a barrier to the free liquid but constant pressure of 1 to 5 bars continues to push the free liquid out of the inner and outer bags.

Design:

A critical point in design is to make the bags large enough so that they are capable of one continuous pumping cycle example: 8 hours, 12 hours, 24 hours—so they can accommodate various flow rates and different percentages of solids (and sizes) of solids.

This invention is a device, which will be used for de-watering wastewater sludges, which normally contain less than 5% solids, the balance being liquid. For reasons well known to those who are experienced in dealing with waste water treatment it is necessary to continuously separate the liquids from the solids, the objective being to increase the solids component of the sludge to at least 25%. At this point sludge becomes more solid than liquid and, because it is waste product, can be handled, transported and disposed of mechanically rather than hydraulically, much more economically and efficiently.

### BACKGROUND

Various procedures exist for de-watering waste water sludge. These include the use of drying beds, centrifuges, belt presses and geotubes to name but a few. All of these procedures require expensive, highly technical or massive infrastructure to support them, the exception being geotubes. A geotube is a tube or bag made from woven geotextile material, which has proven to be very successful in de-watering sand and mineral slurries that have a specific gravity greater than 1 and a minimum particle size of 1 mm. The material of the geotube permits the solids to settle and the liquids to pass out through the interstices of the material, which are approximately 1 mm in size. The material does not blind because there are no particles small enough to remain stuck in the interstices of the material. This technique does not work well or successfully with waste water sludges because of the nature and size of these solid particles, which vary, being both small and large and generally soft. They therefore tend to block and blind the interstices of the woven material. As the material blinds the liquid cannot escape quickly enough and continued dc-watering beyond a certain point becomes restricted and eventually ceases.

### Component Description

There are two basic components comprising the Sludge Bag:

1. An outer bag providing a strong and stable container of knitted geotextile material.

2. An inner bag made of two layers of knitted nylon material.

Note: Since there are three bags (or bag surfaces) we have tripled the available surface area for free liquid to pass through.

The material of the inner bags has the ability to expand and contract thus retaining and separating solids from liquids and permitting the liquids free of solids to easily pass through the outer bag without restriction. The knitted nylon does not blind because the solids, which do not immediately pass through the first layer of material, being larger than the interstices of the unstretched material, cause a build up of pressure on the surface of this layer. This pressure causes the interstices of the material to expand and pushes the solids through, which are then trapped by the second layer. The liquid will always seek the course of least resistance thereby heading for clear surfaces of knitted nylon bag first. As the bag fills the separation rate will decrease because of build up of solids within the inner bag. After the bag is filled and the bag begins to settle wet spots will begin to form due to the uneven distribution of liquids to solids. This problem is easily solved by letting the bag continue to settle while the free liquids work their way to an unobstructed surface area. The sludge remaining within the inner bag continues to settle and separate liquids from solids from one day to the next—the longer it is left the dryer it becomes. The bags cannot entrap free liquid, which will therefore eventually be released. For the system to work efficiently the bag must be protected from any source of external moisture such as rain or surface runoff.

### DESCRIPTION OF THE SLUDGE BAG OR INVENTION

The outer bag is made from a coarse knitted geotextile material manufactured using polypropylene, polyethylene or any polymer textile as long as the material provides substantial physical strength. It must have a tensile strength of 45 to 50 kN/m². The size of the apertures or interstices must be greater than 50 microns in size permitting liquids to pass freely and retain solids of 60 microns or greater. The size and shape of this bag will depend on other variables. The size can be minimum of 1 m×1 m×1 m up to a maximum of 120 m×4 m×2 m. The shape of the bag will also be dependant on other variables. It can be tube shaped, oval, square, rectangle, triangle etc., as long as the bag is totally or partly closed and contains sludge within. The bag usually has two openings. One to receive the sludge and pass it through the outer bag into the inner bag. The second opening serves as an overflow and prevents the outer bag from bursting under pressure or stress. However, the bags can and will be used as a container with one open panel, the top, which will permit the product to be poured into it until it is full. The product will remain there and continue to de-water and be ready for further handling.

The inner bag consists of two layers of knitted nylon material as described above extended to the full length of the outer bag and only 75% of its width. This requires stretching the material (during manufacturing) to the outer bag before stitching. The stitching also serves to secure the two inner bags in place. The inner bag is totally enclosed by the outer bag except for entry and overflow funnels from outer bag to inner bag.

### Introduction

This inventions is a device which will be used for:

The de-watering of wastewater sludges in flow.

The continuous de-watering and storage of wastewater sludges on site.

Transport, handling and final disposal of the de-watered wastewater sludges.

This invention is made from a composite of knitted geotextile materials, enabling the device to expand and contract, entrapping solids and releasing free-flowing liquids, both immediately and continuously.

There are two basic components of the bag.

An outer bag providing a strong stable container capable of expanding and contracting.

Two inner bags with a greatly enhanced ability to expand and contract.

Since none of the bags are capable of entrapping free liquids the liquid will always choose the path of least resistance and work its way out of the bag. The bags can be emptied and re-used. The method of emptying is dealt with in the description accompanying the drawings.

### The De-Watering Process

The waste water sludge will be pumped directly into the outer bag where the solids will become entrapped and begin settling at the lowest point in the bag, all as more fully described above. Provided the bag is left long enough it is expected that ±99% of all solids will be retained within the inner bags with all the free liquid flowing through the outer bag. Because wastewater sludges vary in consistency depending on the type and origin of the original sewage, the rate of separation and drying will also vary. It is anticipated that the process will dry the solids to a ratio of 25% solids to 75 liquid within 30 days at which stage the solids become an easily transported mass which can be disposed of to solid waste dumps or further processed for use as fertilizers or soil enrichers.

In order for this process to work there must be space for the inner bags to expand and contract as described above. This is the reason for making the inner bags to the same length as the outer bag but only about 75% the diameter when in the unstretched condition. As the bag fills the inner bags expand until they reach the outer bag when no further sludge can be treated. The disposal of the contents, which has become a solid mass of dried sludge, will be described later.

### Methods of Working with Sludge Bags

Drawings illustrate the principles of the sludge bag but each application of these principles will be different, as they will inevitably be related to the actual site where the sludge is to be dealt with. One of the important aspects of this invention is its flexibility in being able to cope with many different situations.

The size of the bag will be decided mainly on site conditions such as ease of access, space available to treat the sludge, the total volume percentage of the solids and other characteristics of the sludge deposit, etc. The bag, or bags, needs to be place in a position they can easily be filled and on an impervious surface which allows the effluent to drain away and be collected for final disposal. This surface will, in most cases, need to be specifically prepared. As the bag gets larger the potential for the development of wet spots increases due to the longer drainage path and the provision of supporting drainage will become necessary. See detail drawing, supporting drainage for large bags.

### DESCRIPTION OF DRAWINGS

Detail design of the bag or bags and their supporting structures also vary depending on site product and purpose. It may be necessary to add additional layers of inner bag for very fine product. A key aspect of the bag is that it can be compiled to de-water, transport and store sludge product while minimizing the smell and ensuring virtually no flies. Now the drawings of the bag will change to suite the specific situation. Example: size of trucks, loading requirements and storage requirements. The mere fact of storing one bag on top of another increases the pressure and de-watering process. Even though the shape, size and combination of function may change and vary the principal remains the same.

FIG. 1—Elevation of Typical 4-sided Sludge Bag with Central Drain

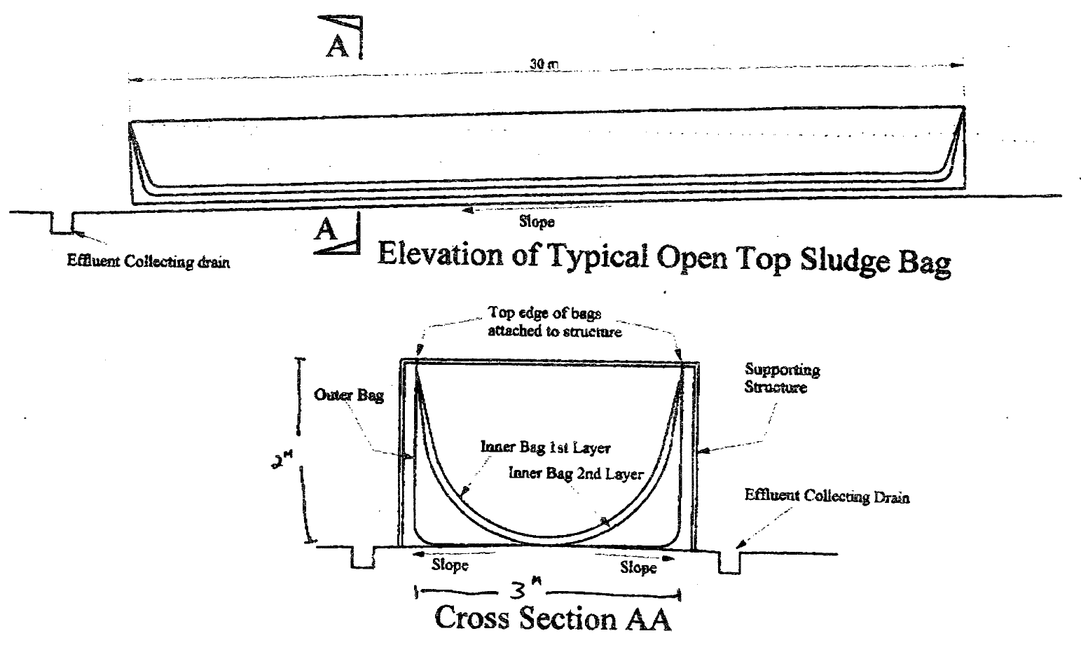

The bags should be placed on a gently sloping surface. When the bags are filled by pumping the liquid sludge from its pond or other containment into the bags the pumping operation needs to be a carefully controlled operation so as to ensure that the filling process proceeds in an orderly manner and that the bags are not filled too quickly. The wider and higher the bags the more the entrapped solids restrict the draining process and therefore require a central drain to assist the draining process.

FIG. 2—Typical Details of Sludge Bag and Central Drain

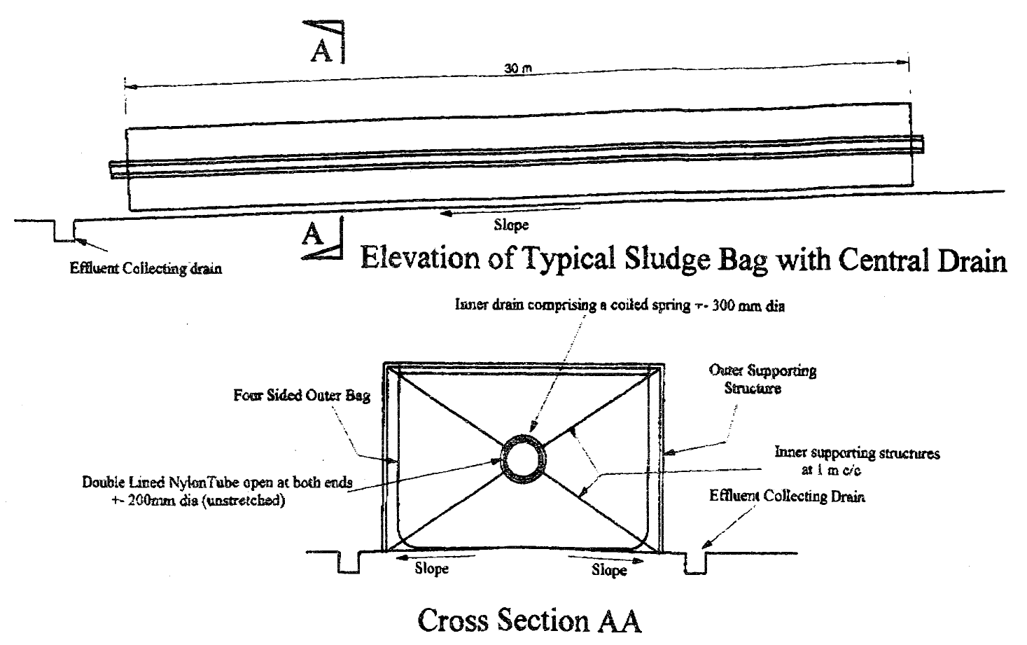

The dimensions of a typical bag would be say width 3.5 meters, height 1.5 meters and length 30 meters. The inner bag is totally enclosed by the outer bag except for the inlet and emergency overflow. Very large bags have inner drain.

The inner drain is a coiled spring of ±300 mm diameter extended the full length of the Sludge Bag and protruding at both ends.

It is then fitted or covered with a double lined Nylon tube, open at both ends, and of ±200 mm diameter and stretched to 300 mm when covering the spring. The spring acts as a frame for the nylon cover, which now permits free flowing liquid to enter and drain out the lower sloping end.

If the outer and inner supporting structures were removed the bag would be oval rather than four-sided.

The method of emptying a four-sided or oval bag is by undoing the velcro and tied seam which runs along the top of the bag for its entire length.

FIG. 3—Elevation of Typical Open-Top Sludge Bag or a Three-sided Sludge Bag

The typical dimensions of this bag would be say width 3 meters, height 1 meter and length 30 meters. This bag requires constant supporting structures in order to function.

FIG. 4—Typical Details of Top-Opening Sludge Bag

The dimensions are the same as above. The method emptying or otherwise disposing of the dried sludge is by removing the frame and collapsing the bag.

SUMMARY

This invention will reduce and de-water the total volume of sludge by 70% to 80% on site and continue the drying process until product is 20% to 25% solids within a short period of time. This assumes that the process started with sludge at less than 5% solids (the balance being liquids).

1. Active mode retains and concentrates solids from free flowing liquids under pressure minimum of 4% to 6% solids immendiately.

2. Passive mode continued de-watering and drying of settled solids and separating liquids from one day to the next. Minimum of only 20% to 25% solids to 30 days.
